(19) United States
(12) Patent Application Publication
(10) Pub. No.: US 2026/0010932 A1
(43) Pub. Date: Jan. 8, 2026

(54) ADVANCED COACHING AND ARTIFICIAL INTELLIGENCE REFINEMENT

(71) Applicant: Avaya Management L.P., Morristown, NJ (US)

(72) Inventor: Thomas Joseph Moran, Castlerea (IE)

(21) Appl. No.: 18/765,480

(22) Filed: Jul. 8, 2024

(51) Int. Cl. G06Q 30/0282; G06Q 30/01

(52) U.S. Cl. CPC G06Q 30/0282; G06Q 30/01

(57) ABSTRACT

Systems and methods are provided to assess a communication conducted over a network. The systems monitor the communication and submit a survey to the customer and agent. The agent may be a human agent or an artificially intelligent (AI) agent. The survey is selected or generated, such as in response to communication content, and presented to the customer and agent. If the scoring is significantly different, an automated agent initiates a remediation action, such as to coach a human agent or to provide feedback or a corrective prompt to an AI agent.

### FIELD OF THE DISCLOSURE

The invention relates generally to systems and methods for identifying and reconciling different experiences with a communication.

### BACKGROUND

For many businesses, a customer care center (or contact center), is an important interface to their customers. Customers often form opinions of a company based on their experience with a contact center and the particular agent they interacted with. As a result, it is critical to know that agents are performing as expected. Customer surveys are a common tool used to determine the customer's impression of the interaction with the agent. However, surveys are often overused or over-inclusive, such as when they comprise many questions that tax customers' time and patience to complete. Even when completed diligently, the data from the surveys often accumulates, such as for monthly reporting. The process of reviewing customer survey results with an agent, including replaying or reviewing a transcript of the communication, is time and resource intensive and requires in-depth analysis.

Increasingly, agents of a contact center are artificially intelligent (AI) agents. AI agents utilize the same types of communication that human agents use, including voice, video, simple messaging service (SMS) text, social media chat, email, etc. While they may deliver factually accurate content they, like their human counterparts, may interrupt, say something inappropriate, be overly blunt, dismiss a point raised, or otherwise interact with a customer in a way that may create a negative (or positive) impression for the customer.

Knowing how agents, whether human or AI, perform during a call can be of critical importance to businesses.

### SUMMARY

These and other needs are addressed by the various embodiments and configurations of the present invention. The present invention can provide a number of advantages depending on the particular configuration. These and other advantages will be apparent from the disclosure of the invention(s) contained herein.

An agent, or agents, may not always interact with customers as the business intends, whether it's a single agent that may need a break or additional training, or a number of agents that are diligently following a prescribed, but flawed, procedure. However, some communications are more (or less) challenging than others. This may be due to the subject matter of the communication or the personality of the customer and/or agent (human or AI). If a post-communication survey of the agent and customer both agree (e.g., both agree that the communication went well, did not go well, or was merely average), then the business has an accurate perception of the communication and may proceed accordingly. However, if the post-communication surveys are not in agreement (e.g., only one of the customer or the agent believed the communication went well, poorly, or average), then there is a misunderstanding or erroneous assumption about the performance of the communication.

In one embodiment, detecting the presence of a misunderstanding or erroneous assumption about the performance of the communication is provided and a response thereto determined and executed. The response may be executed in near real-time (e.g., as soon as the last of the agent or customer completes their survey). As a benefit, the human agent, supervisor, and/or automated system may be promptly notified and corrective action taken while the communication is fresh in the mind of a human agent. A supervisor and/or automated agent may then conduct a targeted coaching session with the agent to address the discrepancy. One or more of the communication session, agent survey, customer survey, coaching session, or combinations thereof may be saved for subsequent review, such as to determine any long-term trends. The survey may be submitted after the communication has ended or during the communication, such as in the form of a graphical element on a computer display to indicate satisfaction or dual-tone multi-frequency (DTMF) key entry (e.g., “At any time during the call, press 1 to indicate the call is satisfactory, press 2 to indicate average satisfaction, and press 3 to indicate the call is unsatisfactory”).

When the agent is an AI agent, a misunderstanding may be provided to the AI agent machine learning algorithm as feedback and/or the particular AI agent persona may be down-weighted so as to be selected less frequently for future communications.

In another embodiment, the contact center utilizes an Automatic Quality Monitoring (AQM) system comprising an AI to continuously analyze communications and rate the quality of the response to the communication. Both the customer and the AQM ratings may be analyzed in near real time, and in cases where there is a significant mismatch between the customer and AQM perception of the contact, an alert is created that is then used to investigate/improve the AI system.

Addressing a mismatch between a customer's and agent's experiences with a communication not only affects the customer's perception of the business, but alleviates the burden on computing and networking components. When a communication goes poorly, a customer may need to call back or initiate another type of communication. Every time a communication is initiated, systems are utilized to initiate the communication, access records, determine an agent, route the communication to the selected agent, etc. If the customer abandons the call before the work item associated with the call is completed, or if multiple work items are contemplated but the customer decides to not pursue resolution of all the work items during this particular communication, additional computing and network resources are then necessary to establish a subsequent communication to resolve the remaining work items.

In some aspects, the techniques described herein relate to a method, including: monitoring, by a microprocessor, a communication, via a network, between a customer device utilized by a customer and an agent device utilized by an agent; presenting, by the microprocessor, a customer survey to the customer device to solicit feedback on the communication; presenting, by the microprocessor, an agent survey to the agent device to solicit feedback on the communication; generating, by the microprocessor, a customer survey score from the customer survey; generating, by the microprocessor, an agent survey score from the agent survey; determining, by the microprocessor, a difference between the agent survey score and the customer survey score; and the microprocessor, upon determining the difference is greater than a threshold, performing a remediation action.

In some aspects, the techniques described herein relate to a method, further including: generating, by the microprocessor, a training set including at least one of the communication, customer survey, agent survey, the customer survey score, the agent survey score, and the difference; and wherein the agent includes an artificial intelligence (AI) agent; wherein the agent device includes a neural network executing the AI agent; and wherein the remediation action includes providing the training set to the neural network.

In some aspects, the techniques described herein relate to a method, further including: generating, by the microprocessor, a prompt including at least one of the communication, the customer survey, the agent survey, the customer survey score, the agent survey score, and the difference; and wherein the agent includes an artificial intelligence (AI) agent; wherein the agent device includes a machine learning algorithm executing the AI agent; and wherein the remediation action includes providing the prompt to the machine learning algorithm.

In some aspects, the techniques described herein relate to a method, wherein: the agent includes a human agent; and the remediation action includes a coaching session presented on the agent device.

In some aspects, the techniques described herein relate to a method, wherein at least one of the customer survey and the agent survey are conducted while the communication is ongoing.

In some aspects, the techniques described herein relate to a method, wherein the customer survey is a portion of a master customer survey for a plurality of communications including the agent, and wherein at least one other portion of the master customer survey is presented to at least one other customer during a prior communication.

In some aspects, the techniques described herein relate to a method, wherein the customer survey includes a random portion of the master customer survey.

In some aspects, the techniques described herein relate to a method, including: monitoring, by a first artificial intelligence (AI) agent, a communication, via a network, between a customer device utilized by a customer and a second artificial intelligence (AI) agent; presenting a customer survey to the customer device to solicit feedback on the communication; causing the second AI agent to respond to an agent survey to provide feedback on the communication; generating a customer survey score from the customer survey; generating an agent survey score from the agent survey; determining a difference between the agent survey score and the customer survey score; and upon determining the difference is greater than a threshold, performing a remediation action.

In some aspects, the techniques described herein relate to a method, further including: generating a training set including at least one of the communication, the customer survey, the agent survey, the customer survey score, the agent survey score, and the difference; and wherein the second AI agent includes a neural network executing the second AI agent; and wherein the remediation action includes providing the training set to the neural network.

In some aspects, the techniques described herein relate to a method, further including: generating a prompt including at least one of the communication, the customer survey, the agent survey, the customer survey score, the agent survey score, and the difference; and wherein the agent device includes a machine learning algorithm executing the second AI agent; and wherein the remediation action includes providing the prompt to the machine learning algorithm.

In some aspects, the techniques described herein relate to a method, wherein the second AI agent includes a neural network trained with a dataset including a plurality of past communications.

In some aspects, the techniques described herein relate to a method, wherein the first AI agent includes a neural network trained with a dataset including a plurality of past communications, corresponding past customer surveys, and a set of communication features.

In some aspects, the techniques described herein relate to a method, wherein the communication features include at least one of pace of speech, volume of speech, intonation, accent, word choice, and pauses or other absent speech.

In some aspects, the techniques described herein relate to a system, including: at least one microprocessor coupled with a computer memory including computer readable instructions that, when read by the at least one microprocessor, cause the at least one microprocessor to: monitor a communication, via a network, between a customer device utilized by a customer and an agent device utilized by an agent; present a customer survey to the customer device to solicit feedback on the communication; present an agent survey to the agent device to solicit feedback on the communication; generate a customer survey score from the customer survey; generate an agent survey score from the agent survey; determine a difference between the agent survey score and the customer survey score; and upon determining the difference is greater than a threshold, perform a remediation action.

In some aspects, the techniques described herein relate to a system, further including instructions to cause the at least one microprocessor to: generate a training set including at least one of the communication, the customer survey, the agent survey, the customer survey score, the agent survey score, and the difference; and execute the agent including an artificial intelligence (AI) agent; wherein the agent device includes a neural network executing the AI agent; and wherein the remediation action includes providing the training set to the neural network.

In some aspects, the techniques described herein relate to a system, further including instructions to cause the at least one microprocessor to: generate a prompt including at least one of the communication, the customer survey, the agent survey, the customer survey score, the agent survey score, and the difference; and execute the agent including an artificial intelligence (AI) agent; and wherein the agent device includes a machine learning algorithm executing the AI agent; and wherein the remediation action includes providing the prompt to the machine learning algorithm.

In some aspects, the techniques described herein relate to a system, wherein: the agent includes a human agent; and the instructions further include instructions to cause the at least one microprocessor to execute the remediation action including a coaching session presented on the agent device.

In some aspects, the techniques described herein relate to a system, wherein at least one of the customer survey and the agent survey are conducted while the communication is ongoing.

In some aspects, the techniques described herein relate to a system, wherein the customer survey is a portion of a master customer survey for a plurality of communications including the agent, and wherein at least one other portion of the master customer survey is presented to at least one other customer during a prior communication.

In some aspects, the techniques described herein relate to a system, wherein the customer survey includes a random portion of the master customer survey.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a system in accordance with embodiments of the present disclosure;

FIG. 3 depicts a process in accordance with embodiments of the present disclosure; and

FIG. 4 depicts a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

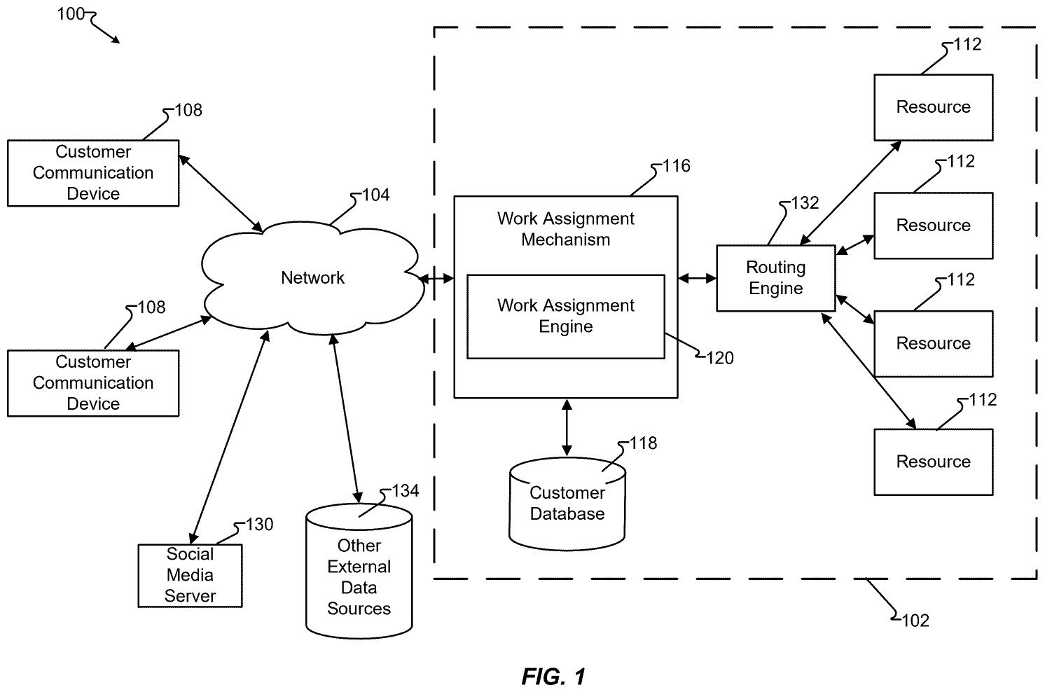

FIG. 1 depicts communication system 100 in accordance with at least some embodiments of the present disclosure. The communication system 100 may be a distributed system and, in some embodiments, comprise a communication network 104 connecting one or more customer communication devices 108 to a work assignment mechanism 116, which may be owned and operated by an enterprise administering contact center 102 in which a plurality of resources 112 is distributed to handle incoming work items (in the form of contacts) from customer communication devices 108.

Contact center 102 is variously embodied to receive and/or send messages that are themselves, or are associated with, work items and the processing and management (e.g., scheduling, assigning, routing, generating, accounting, receiving, monitoring, reviewing, etc.) of the work items by one or more resources 112. The work items are generally generated and/or received requests for a processing resource 112 embodied as, or a component of, an electronic and/or electromagnetically conveyed message. Contact center 102 may include more or fewer components than illustrated and/or provide more or fewer services than illustrated. The border indicating contact center 102 may be a physical boundary (e.g., a building, campus, etc.), a legal boundary (e.g., a company, enterprise, etc.), and/or a logical boundary (e.g., resources 112 utilized to provide services to customers for a customer of contact center 102).

Furthermore, the border illustrating contact center 102 may be as-illustrated or, in other embodiments, include alterations and/or more and/or fewer components than illustrated. For example, in other embodiments, one or more of resources 112, customer database 118, and/or other components may connect to routing engine 132 via communication network 104, such as when such components connect via a public network (e.g., Internet). In another embodiment, communication network 104 may be a private utilization of, at least in part, a public network (e.g., a VPN); a private network located, at least partially, within contact center 102; or a mixture of private and public networks that may be utilized to provide electronic communication of components described herein. Additionally, it should be appreciated that components illustrated as external, such as social media server 130 and/or other external data sources 134, may be within contact center 102 physically and/or logically, but still be considered external for other purposes (e.g., system administration). For example, contact center 102 may operate social media server 130 (e.g., a website operable to receive user messages from customers and/or resources 112) as one means to interact with customers via their customer communication device 108.

Customer communication devices 108 are embodied as external to contact center 102 as they are under the more direct control of their respective user or customer. However, embodiments may be provided whereby one or more customer communication devices 108 are physically and/or logically located within contact center 102 and are still considered external to contact center 102, such as when a customer utilizes customer communication device 108 at a kiosk and attaches to a private network of contact center 102 (e.g., WiFi connection to a kiosk, etc.), within or controlled by contact center 102.

It should be appreciated that the description of contact center 102 provides at least one embodiment whereby the following embodiments may be more readily understood without limiting such embodiments. Contact center 102 may be further altered, added to, and/or subtracted from without departing from the scope of any embodiment described herein and without limiting the scope of the embodiments or claims, except as expressly provided.

Additionally, contact center 102 may incorporate and/or utilize social media server 130, and/or other external data sources 134 may be utilized to provide one means for a resource 112 to receive and/or retrieve contacts and connect to a customer of a contact center 102. Other external data sources 134 may include data sources, such as service bureaus, third-party data providers (e.g., credit agencies, public and/or private records, etc.). Customers may utilize their respective customer communication device 108 to send/receive communications utilizing social media server 130.

In accordance with at least some embodiments of the present disclosure, the communication network 104 may comprise any type of known communication medium or collection of communication media and may use any type of protocols to transport electronic messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through various telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VOIP) network, a cellular network, and any other type of packet-switched or circuit-switched network known in the art. In addition, it can be appreciated that the communication network 104 need not be limited to any one network type and instead may be comprised of a number of different networks and/or network types. As one example, embodiments of the present disclosure may be utilized to increase the efficiency of a grid-based contact center 102. Examples of a grid-based contact center 102 are more fully described in U.S. Patent Publication No. 2010/0296417 to Steiner, the entire contents of which are hereby incorporated herein by reference. Moreover, the communication network 104 may comprise a number of different communication media, such as coaxial cable, copper cable/wire, fiber-optic cable, antennas for transmitting/receiving wireless messages, and combinations thereof.

The customer communication devices 108 may correspond to a particular customer(s). In accordance with at least some embodiments of the present disclosure, a customer may utilize their customer communication device 108 to initiate a work item. Illustrative work items include, but are not limited to, a contact directed toward and received at a contact center 102, a web page request directed toward and received at a server farm (e.g., a collection of servers), a media request, an application request (e.g., a request for an application resource location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media server 130 or network of servers. Exemplary architectures for harvesting social media communications and generating work items based thereon are described in U.S. patent application Ser. Nos. 12/784,369, 12/706,942, and 12/707,277, filed May 20, 2010, Feb. 17, 2010, and Feb. 17, 2010, respectively; each of which is hereby incorporated herein by reference in its entirety.

The format of the work item may depend upon the capabilities of the customer communication device 108 and/or the format of the communication. In particular, work items are logical representations of work to be performed in connection with servicing a communication received at contact center 102 (and, more specifically, the work assignment mechanism 116). The communication may be received and maintained at the work assignment mechanism 116, a switch or server connected to the work assignment mechanism 116, or the like, until a resource 112 is assigned to the work item representing that communication. At which point, the work assignment mechanism 116 passes the work item to a routing engine 132 to connect the customer communication device 108, which initiated the communication, with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the customer communication devices 108 may comprise any type of known communication equipment or collection of communication equipment. Examples of a suitable customer communication device 108 includes, but are not limited to, a personal computer, laptop, Personal Digital Assistant (PDA), cellular phone, smart phone, telephone, or combinations thereof. In general, each customer communication device 108 may be adapted to support video, audio, text, and/or data communications with other customer communication devices 108 as well as the processing resources 112. The type of medium used by the customer communication device 108 to communicate with other customer communication devices 108 or processing resources 112 may depend upon the communication applications available on the customer communication device 108.

In accordance with at least some embodiments of the present disclosure, the work item is sent to a collection of processing resources 112 via the combined efforts of the work assignment mechanism 116 and routing engine 132. The resources 112 can either be completely automated resources (e.g., Interactive Voice Response (IVR) units, microprocessors, servers, or the like), human resources utilizing communication devices (e.g., human agents utilizing a computer, telephone, laptop, etc.), or any other resource known to be used in contact center 102.

As discussed above, the work assignment mechanism 116 and resources 112 may be owned and operated by a common entity in a contact center 102 format. In some embodiments, the work assignment mechanism 116 may be administered by multiple enterprises, each of which has its own dedicated resources 112 connected to the work assignment mechanism 116.

In some embodiments, the work assignment mechanism 116 comprises a work assignment engine 120, which enables the work assignment mechanism 116 to make intelligent routing decisions for work items. In some embodiments, the work assignment engine 120 is configured to administer and make work assignment decisions in a queueless contact center 102, as is described in U.S. Pat. No. 8,634,543 issued on Jan. 21, 2014, the entire contents of which are hereby incorporated herein by reference. In other embodiments, the work assignment engine 120 may be configured to execute work assignment decisions in a traditional queue-based (or skill-based) contact center 102.

The work assignment engine 120 and its various components may reside in the work assignment mechanism 116 or in a number of different servers or processing devices. In some embodiments, cloud-based computing architectures can be employed whereby one or more hardware components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to contact center 102. Customer database 118 may be updated in response to a work item and/or input from resource 112 processing the work item.

It should be appreciated that one or more components of contact center 102 may be implemented in a cloud-based architecture in their entirety, or components thereof (e.g., hybrid), in addition to embodiments being entirely on-premises. In one embodiment, customer communication device 108 is connected to one of resources 112 via components entirely hosted by a cloud-based service provider, wherein processing and data storage hardware components may be dedicated to the operator of contact center 102 or shared or distributed among a plurality of service provider customers, one being contact center 102.

In one embodiment, a message is generated by customer communication device 108 and received via communication network 104 at work assignment mechanism 116. The message received by a contact center 102, such as at the work assignment mechanism 116, is generally, and herein, referred to as a “contact.” Routing engine 132 routes the contact to at least one of resources 112 for processing.

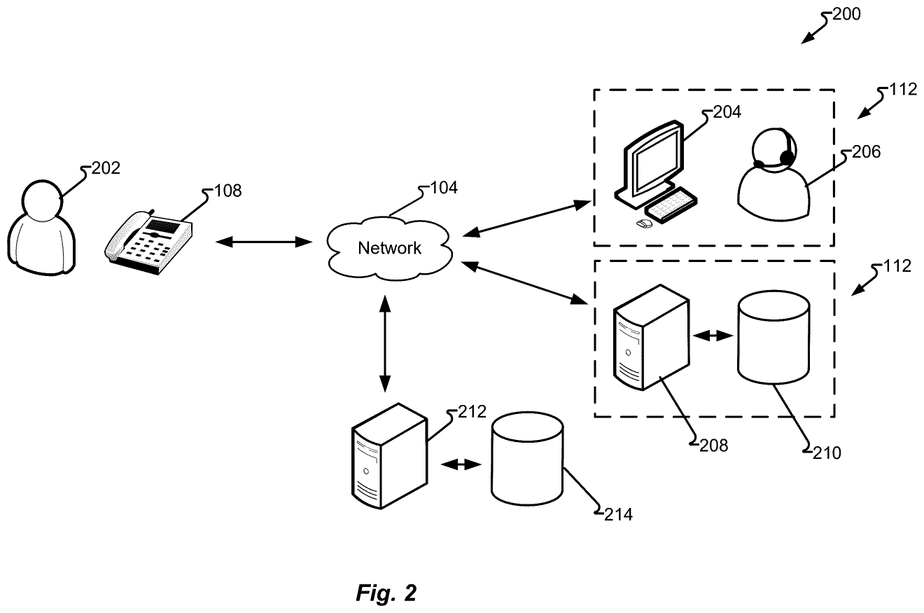

FIG. 2 depicts system 200 in accordance with embodiments of the present disclosure. In one embodiment, system 200 illustrates components and/or capabilities of contact center 102. It will be appreciated by those of ordinary skill in the art that the topology illustrated by system 200 may be modified, such as to combine components, separate components, and/or utilize different network connectivity architectures without departing from the scope of the disclosure. A communication is initiated for the purpose of resolving a work item. For example, customer 202 may have a question or may need to provide information to contact center 102 via resource 112.

In one embodiment, customer 202 using customer communication device 108 communicates with a particular resource 112, such as human agent 206, using agent communication device 204, via network 104. The communication may comprise audio, video, text, and/or combinations thereof. Server 212 monitors the communication, which may include recording, such as for storage in data storage 214 for later analysis. Server 212 may note key satisfaction indicators, such as customer 202 becoming angry, agent 206 becoming frustrated, or other indicators that may cause the resolution of the work item to be delayed or to fail.

In another embodiment, server 212 may provide a survey to customer 202, via customer communication device 108, and/or human agent 206 via agent communication device 204. The survey may be previously determined or generated by server 212. For example, data storage 214 may comprise a master survey, which may comprise many questions (e.g., several dozen to hundreds). Asking customers and agents to spend that amount of time to complete a survey is more likely to result in irritation and less likely to result in a completed survey. Accordingly, server 212 may generate a survey as a portion of the master survey. The generation may comprise randomly or “round robin” selecting a number of questions, such as those questions that are likely to be answered within a threshold amount of time (e.g., one minute). The questions of the master survey may all be presented in a plurality of survey portions presented to a plurality customers 202 regarding an associated plurality of communications. For example, a first customer 202 is asked the first three questions, the second customer 202 is asked the next three questions, and so on.

In another embodiment, server 212 executes an AI monitoring agent to generate questions specifically related to the content of the communication between customer 202 and agent 206. For example, server 212 may execute an unsupervised AI monitoring agent to receive the communication, and a number of past communications (preferably many thousands), as an input. The AI monitoring agent may then be trained to identify aspects of the communication that require clarification, such as to their cause. For example, the AI monitoring agent may determine that the communication begins amicably but customer 202 becomes irritated. If the customer states a clear reason (e.g., “I've given you my account number four times now.”), then there may not be any ambiguity as to the cause of the customer's irritation and, as a result, other questions may be generated or selected. However, if the customer's irritation is unclear, the AI monitoring agent may be trained using a set of inputs (e.g., past communications) and outputs (e.g., a question that effectively determined the cause or reason for a particular communication portion), then supervised learning may be utilized by the AI monitoring agent to determine associations therebetween. As a result, a question may be learned that will solicit an accurate indicator as to why customer 202 became irritated.

Similarly, human agent 206 may be presented with a survey to determine the agent's opinion of how the communication went. For example, it may be a known issue with the user interface of agent communication device 204 that account numbers are not saved from one portion to another portion, and thus the issue requires human agent 206 to ask customer 202 repeatedly for an account number. Human agent 206 may be unsurprised that customer 202 become irritated by repeatedly being asked for the account number and answer a survey question accordingly. Generally, when the surveys presented to customer 202 and human agent 206 agree (e.g., both thought the communication went well, poorly, etc.), then existing procedures are often sufficient to address the survey responses. However, when there is a disagreement between the survey completed by customer 202 and the survey completed by human agent 206, then additional analysis may be required.

In one embodiment, the presence of a disagreement in the results or scores of the customer survey and agent survey may result in an additional question(s) being generated by server 212 executing the AI monitoring agent and specifically determined to resolve the ambiguity of a previous question.

In another embodiment, a disagreement in the results or scores of the customer survey and agent survey may be resolved by further accessing a history of surveys for customer 202 and/or agent 206. For example, customer 202/human agent 206 may be known to always score answers a particular way (e.g., always high, always low, always middle, etc.). If customer 202 always answers questions low, but human agent 206 always answers the questions high, then further analysis may be unnecessary. However, when such disagreements are present and not otherwise explained, the communication may be analyzed by server 212 executing an AI monitoring agent to receive the communication, customer survey, agent survey, customer survey score, agent survey score, and/or combinations thereof as an input to produce an output. The AI monitoring agent may be operated as an unsupervised AI in order to determine an unknown output. For example, human agent 206 may have attempted to inject some humor into the communication, but customer 202 found the attempt condescending or patronizing but said nothing during the communication.

In one embodiment, customer 202, using customer communication device 108, communicates with a particular resource 112, such as artificial intelligent (AI) agent 208, via network 104. Similar to when resource 112 is human agent 206, server 212 monitors the communication and presents a customer survey to customer 202 via customer communication device 108 and an agent survey to a server executing AI agent 208. AI agent 208 may utilize data storage 210, such as to maintain training data and/or other information.

In another embodiment, server 212 may determine a discrepancy exists between the customer survey (or the customer survey score) and the agent survey (or the agent survey score), which is greater than a previously determined threshold and, in response, initiate a remediation. When the surveys are conducted while the communication is ongoing, a supervisor, which may be a human agent having more experience or authority, may be notified and manually or automatically connected to the communication. The supervisor may then take over the communication on behalf of resources 112 or provide other assistance such as whisper chat to human agent 206 or additional inputs to AI agent 208 (e.g., “slow down the rate of speech”, “increase empathy,” etc.).

When resources 112 comprises human agent 206, remediation may include presenting a coaching session, such as one to specifically address the difference in survey scores. Preferably the coaching session is provided as soon as possible so that the human agent 206 is more likely to accurately remember and recall the communication.

When resource 112 comprises AI agent 208, remediation may include generating feedback based on the survey and/or differences in survey scores. For example, a prompt may be provided comprising the communication, a survey score or result (e.g., “agent was abrupt and cold”), and a desired result (e.g., “be more conversational, increase pauses before speaking,” etc.) and provided to AI agent 208 as a feedback prompt. Similarly, such a prompt may be provided to a separate AI agent as a portion of the initial training dataset.

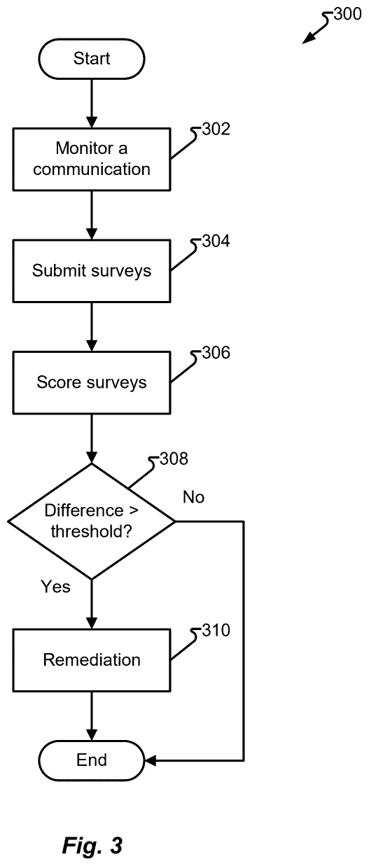

FIG. 3 depicts process 300 in accordance with embodiments of the present disclosure. In one embodiment, process 300 is embodied as machine-readable instructions maintained in a non-transitory memory that when read by a machine, such as processors of a server, cause the machine to execute the instructions and thereby execute process 300. The processor of the server may include, but is not limited to, at least one processor of server 212. Furthermore, the steps illustrated herein are one embodiment that describe operations, and those of ordinary skill in the art will recognize that certain steps of process 300 may be reordered, combined, and/or separated without departing from the scope of the disclosure.

Process 300 begins and, in step 302, a communication is monitored. The communication may comprise audio, video, text, or combinations thereof and be in real-time (e.g., audio comprising live speech), near real-time (e.g., text), or non-real-time (e.g., email). The communication comprises communication content (e.g., speech, words, video images, etc.) encoded for transmission via network 104 between a customer (e.g., customer 202) and an agent (e.g., one of resources 112). Monitoring step 302 may comprise a server (e.g., server 212) intercepting the communication when live or analyzing a recording of the communication.

After or during the communication, step 304 submits a survey to the customer and agent. The survey may be, in whole or in part, generated based upon attributes of the communication. Attributes of the communication include, but are not limited to, voice tone, volume of speech, pace of speech, intonation, accent, pauses that are absent speech, gestures, facial expressions, emojis, indications of satisfaction, indications of displeasure, emotionally charged word choice, and the rate of change thereof as well as combinations of the forgoing. The survey(s) may comprise a limited set of questions selected from a larger, master survey that are selected randomly, pseudo-randomly, “round robin,” or via other selection means. The generation of questions may be provided by an AI agent (e.g., server 212 comprising an AI monitoring agent) provided with a training set to determine questions related to the communication.

Step 304 then submits the survey to the customer, such as via customer communication device 108, and to the agent, such as via agent communication device 204 or an interface of AI agent 208. The questions of the survey may be provided as a graphical interface, DTMF selection, etc. For example, customer 202 may be presented with instructions to “Press 1 if you are happy with the call.”

Step 306 scores the surveys. Scoring may comprise assigning a numerical value to a single question of the survey or the survey overall, such as when the questions of the survey have a similar subject (e.g., a set of questions designed to determine if the customer found the agent to be empathetic or not). Test 308 then determines if there was a difference in the customer survey score and the agent survey score that is greater than a previously determined value (e.g., historic value known to delineate relevance, a standard deviation, etc.). If test 308 is determined in the negative, process 300 may end. If test 308 is determined in the affirmative, processing continues to step 310 wherein a remediation action is performed or triggered to be performed.

Certain embodiments herein may implement an AI agent as a neural network. A neural network, as is known in the art and in one embodiment, self-configures layers of logical nodes having an input and an output. If an output is below a self-determined threshold level, the output is omitted (i.e., the inputs are within the inactive response portion of a scale and provide no output). If the self-determined threshold level is above the threshold, an output is provided (i.e., the inputs are within the active response portion of a scale and provide an output). The particular placement of the active and inactive delineation is provided as a training step or steps. Multiple inputs into a node produce a multi-dimensional plane (e.g., hyperplane) to delineate a combination of inputs that are active or inactive.

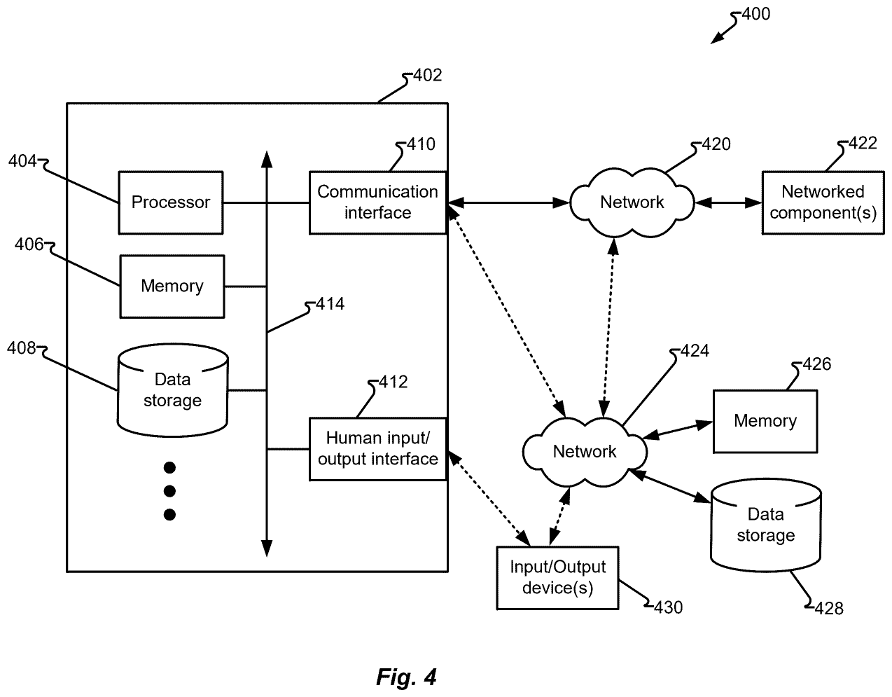

FIG. 4 depicts device 402 in system 400 in accordance with embodiments of the present disclosure. In one embodiment, server 212 and/or agent communication device 204 may be embodied, in whole or in part, as device 402 comprising various components and connections to other components and/or systems. The components are variously embodied and may comprise processor 404. The term “processor,” as used herein, refers exclusively to electronic hardware components comprising electrical circuitry with connections (e.g., pin-outs) to convey encoded electrical signals to and from the electrical circuitry. Processor 404 may comprise programmable logic functionality, such as determined, at least in part, from accessing machine-readable instructions maintained in a non-transitory data storage, which may be embodied as circuitry, on-chip read-only memory, computer memory 406, data storage 408, etc., that cause the processor 404 to perform the steps of the instructions. Processor 404 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 414, executes instructions, and outputs data, again such as via bus 414. In other embodiments, processor 404 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 404 is a non-transitory computing device (e.g., electronic machine comprising circuitry and connections to communicate with other components and devices). Processor 404 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 404). Processor 404 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 404, device 402 may utilize computer memory 406 and/or data storage 408 for the storage of accessible data, such as instructions, values, etc. Communication interface 410 facilitates communication with components, such as processor 404 via bus 414 with components not accessible via bus 414 and may be embodied as a network interface (e.g., ethernet card, wireless networking components, USB port, etc.). Communication interface 410 may be embodied as a network port, card, cable, or other configured hardware device. Additionally or alternatively, human input/output interface 412 connects to one or more interface components to receive and/or present information (e.g., instructions, data, values, etc.) to and/or from a human and/or electronic device. Examples of input/output devices 430 that may be connected to input/output interface include, but are not limited to, keyboard, mouse, trackball, printers, displays, sensor, switch, relay, speaker, microphone, still and/or video camera, etc. In another embodiment, communication interface 410 may comprise, or be comprised by, human input/output interface 412. Communication interface 410 may be configured to communicate directly with a networked component or configured to utilize one or more networks, such as network 420 and/or network 424.

Network 104 may be embodied, in whole or in part, as network 420. Network 420 may be a wired network (e.g., Ethernet), wireless (e.g., WiFi, Bluetooth, cellular, etc.) network, or combination thereof and enable device 402 to communicate with networked component(s) 422. In other embodiments, network 420 may be embodied, in whole or in part, as a telephony network (e.g., public switched telephone network (PSTN), private branch exchange (PBX), cellular telephony network, etc.).

Additionally or alternatively, one or more other networks may be utilized. For example, network 424 may represent a second network, which may facilitate communication with components utilized by device 402. For example, network 424 may be an internal network to a business entity or other organization, such as contact center 102, whereby components are trusted (or at least more so) than networked components 422, which may be connected to network 420 comprising a public network (e.g., Internet) that may not be as trusted.

Components attached to network 424 may include computer memory 426, data storage 428, input/output device(s) 430, and/or other components that may be accessible to processor 404. For example, computer memory 426 and/or data storage 428 may supplement or supplant computer memory 406 and/or data storage 408 entirely or for a particular task or purpose. As another example, computer memory 426 and/or data storage 428 may be an external data repository (e.g., server farm, array, “cloud,” etc.) and enable device 402, and/or other devices, to access data thereon. Similarly, input/output device(s) 430 may be accessed by processor 404 via human input/output interface 412 and/or via communication interface 410 either directly, via network 424, via network 420 alone (not shown), or via networks 424 and 420. Each of computer memory 406, data storage 408, computer memory 426, data storage 428 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 430 may be a router, a switch, a port, or other communication component such that a particular output of processor 404 enables (or disables) input/output device 430, which may be associated with network 420 and/or network 424, to allow (or disallow) communications between two or more nodes on network 420 and/or network 424. For example, a connection between one particular customer, using a particular customer communication device 108, may be enabled (or disabled) with a particular networked component 422 and/or particular resource 112. Similarly, one particular networked component 422 and/or resource 112 may be enabled (or disabled) from communicating with a particular other networked component 422 and/or resource 112, including, in certain embodiments, device 402 or vice versa. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

1. A method, comprising:
monitoring, by a microprocessor of a communication monitoring system, a communication, via a network, between a customer device utilized by a customer and an agent device utilized by an agent;
presenting, by the microprocessor through a graphical user interface rendered on the customer device, a customer survey comprising user interface elements configured to solicit feedback on the communication;
presenting, by the microprocessor through a graphical user interface rendered on the agent device, an agent survey comprising user interface elements configured to solicit feedback on the communication;
generating, by the microprocessor, a customer survey score from responses from the customer device by converting the responses into a numerical score and storing the numerical score in a database associated with the communication;
generating, by the microprocessor, an agent survey score from responses from the agent device by converting the responses into a numerical score and storing the numerical score in the database associated with the communication;
computing, by the microprocessor, a difference value between the agent survey score and the customer survey score; and
responsive to determining that the difference value exceeds a programmable threshold, the microprocessor automatically initiating a remediation action comprising triggering a notification message to a supervisory system.

2. The method of claim 1, further comprising:
generating, by the microprocessor, a training set comprising at least one of the communication, customer survey, agent survey, the customer survey score, the agent survey score, and the difference; and
wherein the agent comprises an artificial intelligence (AI) agent;
wherein the agent device comprises a neural network executing the AI agent; and
wherein the remediation action comprises providing the training set to the neural network.

3. The method of claim 1, further comprising:
generating, by the microprocessor, a prompt comprising at least one of the communication, the customer survey, the agent survey, the customer survey score, the agent survey score, and the difference; and
wherein the agent comprises an artificial intelligence (AI) agent;
wherein the agent device comprises a machine learning algorithm executing the AI agent; and
wherein the remediation action comprises providing the prompt to the machine learning algorithm.

4. The method of claim 1, wherein:
the agent comprises a human agent; and
the supervisory system automatically connects to the communication and either takes over the communication or provides assistance to the human agent.

5. The method of claim 1, wherein at least one of the customer survey and the agent survey are conducted while the communication is ongoing.

6. The method of claim 1, wherein the customer survey is a portion of a master customer survey for a plurality of communications comprising the agent, and wherein at least one other portion of the master customer survey is presented to at least one other customer during a prior communication.

7. The method of claim 6, wherein the customer survey comprises a random portion of the master customer survey.

8. A method, comprising:
monitoring, by a first artificial intelligence (AI) agent, a communication, via a network, between a customer device utilized by a customer and a second artificial intelligence (AI) agent;
presenting through a graphical user interface rendered on the customer device a customer survey comprising user interface elements configured to solicit feedback on the communication;
causing the second AI agent to respond to an agent survey to provide feedback on the communication;
generating a customer survey score from responses from the customer device by converting the responses into a numerical score and storing the numerical score in a database associated with the communication;
generating an agent survey score from responses from the agent device by converting the responses into a numerical score and storing the numerical score in the database associated with the communication;
computing a difference value between the agent survey score and the customer survey score; and
responsive to determining that the difference value exceeds a programmable threshold, automatically initiating a remediation action comprising triggering a notification message to a supervisory system.

9. The method of claim 8, further comprising:
generating a training set comprising at least one of the communication, the customer survey, the agent survey, the customer survey score, the agent survey score, and the difference; and
wherein the second AI agent comprises a neural network executing the second AI agent; and
wherein the remediation action comprises providing the training set to the neural network.

10. The method of claim 8, further comprising:
generating a prompt comprising at least one of the communication, the customer survey, the agent survey, the customer survey score, the agent survey score, and the difference; and
wherein the agent device comprises a machine learning algorithm executing the second AI agent; and
wherein the remediation action comprises providing the prompt to the machine learning algorithm.

11. The method of claim 8, wherein the second AI agent comprises a neural network trained with a dataset comprising a plurality of past communications.

12. The method of claim 8, wherein the first AI agent comprises a neural network trained with a dataset comprising a plurality of past communications, corresponding past customer surveys, and a set of communication features.

13. The method of claim 12, wherein the communication features comprise at least one of pace of speech, volume of speech, intonation, accent, word choice, and pauses that are absent speech.

14. A system, comprising:
at least one microprocessor coupled with a computer memory comprising computer readable instructions that, when read by the at least one microprocessor, cause the at least one microprocessor to:
monitor a communication, via a network, between a customer device utilized by a customer and an agent device utilized by an agent;
present through a graphical user interface rendered on the customer device a customer survey comprising user interface elements configured to solicit feedback on the communication;
present through a graphical user interface rendered on the agent device an agent survey comprising user interface elements configured to solicit feedback on the communication;
generate a customer survey score from responses from the customer device by converting the responses into a numerical score and storing the numerical score in a database associated with the communication;
generate an agent survey score from responses from the agent device by converting the responses into a numerical score and storing the numerical score in the database associated with the communication;
compute a difference value between the agent survey score and the customer survey score; and
responsive to determining that the difference value exceeds a programmable threshold, automatically initiate a remediation action comprising triggering a notification message to a supervisory system.

15. The system of claim 14, further comprising instructions to cause the at least one microprocessor to:
generate a training set comprising at least one of the communication, the customer survey, the agent survey, the customer survey score, the agent survey score, and the difference; and
execute the agent comprising an artificial intelligence (AI) agent;
wherein the agent device comprises a neural network executing the AI agent; and
wherein the remediation action comprises providing the training set to the neural network.

16. The system of claim 14, further comprising instructions to cause the at least one microprocessor to:
generate a prompt comprising at least one of the communication, the customer survey, the agent survey, the customer survey score, the agent survey score, and the difference; and
execute the agent comprising an artificial intelligence (AI) agent; and
wherein the agent device comprises a machine learning algorithm executing the AI agent; and
wherein the remediation action comprises providing the prompt to the machine learning algorithm.

17. The system of claim 14, wherein:
the agent comprises a human agent; and
the supervisory system automatically connects to the communication and either takes over the communication or provides assistance to the human agent.

18. The system of claim 14, wherein at least one of the customer survey and the agent survey are conducted while the communication is ongoing.

19. The system of claim 14, wherein the customer survey is a portion of a master customer survey for a plurality of communications comprising the agent, and wherein at least one other portion of the master customer survey is presented to at least one other customer during a prior communication.

20. The system of claim 19, wherein the customer survey comprises a random portion of the master customer survey.
